(19) United States
(12) Patent Application Publication
(10) Pub. No.: US 2021/0191287 A1
(43) Pub. Date: Jun. 24, 2021

(54) BRILLIANT DEVELOPER, DEVELOPER CONTAINER, IMAGE FORMING UNIT, AND IMAGE FORMING APPARATUS

(71) Applicant: Oki Data Corporation, Tokyo (JP)

(72) Inventor: Hayato MATSUMOTO, Tokyo (JP)

(73) Assignee: Oki Data Corporation, Tokyo (JP)

(21) Appl. No.: 17/123,494

(22) Filed: Dec. 16, 2020

(30) Foreign Application Priority Data
Dec. 19, 2019 (JP) 2019-229657

(51) Int. Cl. G03G 9/08; G03G 9/087; G03G 9/09

(52) U.S. Cl. CPC G03G 9/0819; G03G 9/0926; G03G 9/08755

(57) ABSTRACT

A brilliant developer includes toner base particles containing a brilliant pigment and a binder resin, wherein some of the toner base particles each have a recess having an opening width of 11.2±2.7 μm.

### BACKGROUND OF THE INVENTION

### 1. Field of the Invention

Embodiments of the present invention relate to a brilliant developer, a developer container, an image forming unit, and an image forming apparatus, and are preferably applied to, for example, an electrophotographic printer.

### 2. Description of the Related Art

Conventionally, there are widely used image forming apparatuses (or printers) that perform printing processes by forming developer images (or toner images) with developer (or toner) by means of image forming units on the basis of images supplied from computers or the like, transferring the developer images onto media, such as paper, and fixing them by applying heat and pressure.

When an image forming apparatus performs a normal color printing, it uses developers of respective colors of, for example, cyan, magenta, yellow, black, and the like (referred to below as normal colors). These developers contain pigments of the respective colors, binder resins for binding the pigments to media, various external additives, or the like.

Also, by using static electricity, more specifically by applying predetermined high voltages to rollers in image forming units or the like as appropriate, the image forming apparatus sequentially adheres and transfers the developers to rollers, a paper sheet, or the like. Thus, the developers are required to have a certain degree of chargeability. Thus, there is a developer having a chargeability adjusted to an appropriate value by adjusting the amount of external additive having chargeability, adjusting the amount of charge control agent added to a binder resin, or other methods (see, e.g., Japanese Patent Application Publication No. 2018-84677).

Some developers contain metallic pigments for the purpose of exhibiting brilliance or other purposes. Such metallic pigments are sufficiently larger in particle size than pigments for the normal colors. Thus, particles (or toner particles) containing such metallic pigments and binder resins are also sufficiently larger in particle size than toner particles for the normal colors.

As developers containing such metallic pigments are large in particle size, they are small in surface area per unit weight, and low in chargeability, compared to developers for the normal colors.

It is difficult to sufficiently improve the chargeability of a developer containing a metallic pigment, and thus an image forming apparatus using the developer may provide poor print quality.

### SUMMARY OF THE INVENTION

An aspect of the present invention is intended to provide a brilliant developer containing a brilliant pigment and capable of providing high print quality, and a developer container, an image forming unit, and an image forming apparatus that contain the brilliant developer.

According to an aspect of the present invention, there is provided a brilliant developer including toner base particles containing a brilliant pigment and a binder resin, wherein some of the toner base particles each have a recess having an opening width of 11.2±2.7 μm.

According to an aspect of the present invention, there is provided a developer container including a storage portion that contains the above brilliant developer.

According to an aspect of the present invention, there is provided an image forming unit including: an image carrier that carries an electrostatic latent image; a developer carrier that forms a developer image based on the electrostatic latent image on the image carrier; a layer regulating member that abuts the developer carrier; and the above brilliant developer.

According to an aspect of the present invention, there is provided an image forming apparatus including: the above image forming unit; and a fixing unit that fixes the developer image formed by the image forming unit to a medium.

With these aspects, it is possible to provide a brilliant developer containing a brilliant pigment and capable of providing high print quality, and a developer container, an image forming unit, and an image forming apparatus that contain the brilliant developer.

### BRIEF DESCRIPTION OF THE DRAWINGS

In the attached drawings:

FIG. 1 is a left side view illustrating a configuration of an image forming apparatus;

FIG. 2 is a left side view illustrating a configuration of an image forming unit;

FIG. 3 is a perspective view illustrating a configuration of a developer container;

FIG. 4 is a diagram illustrating emission and reception of light by a variable angle photometer;

FIG. 5 is a table showing granulation times, measurement results, and evaluation results of developers;

FIG. 6 is a table showing granulation conditions and measured specific surface areas of developers;

FIG. 7 is a graph showing the relationship between thickness to equivalent circle diameter ratios of developers and FI values;

FIG. 8 is a graph showing the relationship between the thickness to equivalent circle diameter ratios of the developers and color differences ΔE;

FIG. 9 is a graph showing the relationship between the thickness to equivalent circle diameter ratios of the developers and toner charge amounts on a developing roller;

FIG. 10 is a graph showing the relationship between specific surface areas of toner base particles and vertical streak levels;

FIG. 11 is a diagram for explaining brilliance, fog, and vertical streaks in the case of flattened toner base particles and in the case of nearly spherical toner base particles;

FIG. 12 is a diagram for explaining vertical streaks in the case of toner base particles having a small specific surface area and in the case of toner base particles having a large specific surface area;

FIG. 13 shows a transmission electron microscope image of a silver developer;

FIG. 14 is a schematic diagram illustrating a recess opening width and a recess depth;

FIG. 15 is a table showing measurement results obtained by observation of cross-sections of a silver developer;

FIG. 16 is a table showing measurement results obtained by observation of cross-sections of a silver developer of a comparative example;

FIG. 17 is a table showing statistics of the measurement results of FIG. 15;

FIG. 18 is a table showing statistics of the measurement results of FIG. 16; and

FIG. 19 is a diagram illustrating toner base particles.

### DETAILED DESCRIPTION OF THE INVENTION

Embodiments of the present invention will now be described with reference to the drawings.

### 1. CONFIGURATION OF IMAGE FORMING APPARATUS

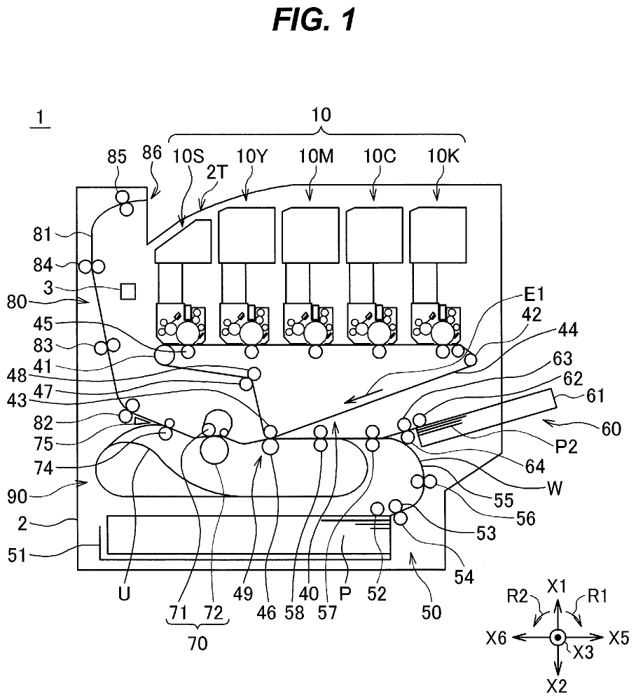

FIG. 1 illustrates an image forming apparatus 1 according to an embodiment. The image forming apparatus 1 is an electrophotographic color printer, and forms (or prints) a color image on a sheet (e.g., paper sheet) P as a medium.

The image forming apparatus 1 is a single function printer (SFP) having a printer function but having neither an image scanner function of reading a document nor a communication function using telephone lines.

The image forming apparatus 1 includes a substantially box-shaped housing 2, in which various components are disposed. The following description assumes that the right end of the image forming apparatus 1 in FIG. 1 is a front side of the image forming apparatus 1, and an up-down direction, a left-right direction, and a front-rear direction are those as viewed toward the front side. In the drawings, the upward, downward, leftward, rightward, forward, and rearward directions are indicated by arrows X1, X2, X3, X4, X5, and X6, respectively.

The image forming apparatus 1 includes a controller 3 that entirely controls the image forming apparatus 1. The controller 3 includes a central processing unit (CPU), a read only memory (ROM), a random access memory (RAM), and the like, which are not illustrated, and performs various processes by reading and executing predetermined programs. Also, the controller 3 is connected wirelessly or by wire to a host apparatus (not illustrated), such as a computer apparatus. Upon receiving, from the host apparatus, image data representing an image to be printed and a command to print the image data, the controller 3 performs a printing process to form a printed image on a surface of a sheet P.

Five image forming units 10K, 10C, 10M, 10Y, and 10S are arranged in this order from the front side toward the rear side, on the upper side of the housing 2. The image forming units 10K, 10C, 10M, 10Y, and 10S correspond to colors of black (K), cyan (C), magenta (M), yellow (Y), and a special color (S), respectively. Although the image forming units 10K, 10C, 10M, 10Y, and 10S correspond to the different colors, they have the same configuration.

The colors of black (K), cyan (C), magenta (M), and yellow (Y), which will be referred to below as normal colors, are colors used in normal color printers. On the other hand, the special color (S) is silver. For convenience of description, the image forming units 10K, 10C, 10M, 10Y, and 10S may be referred to below as image forming units 10.

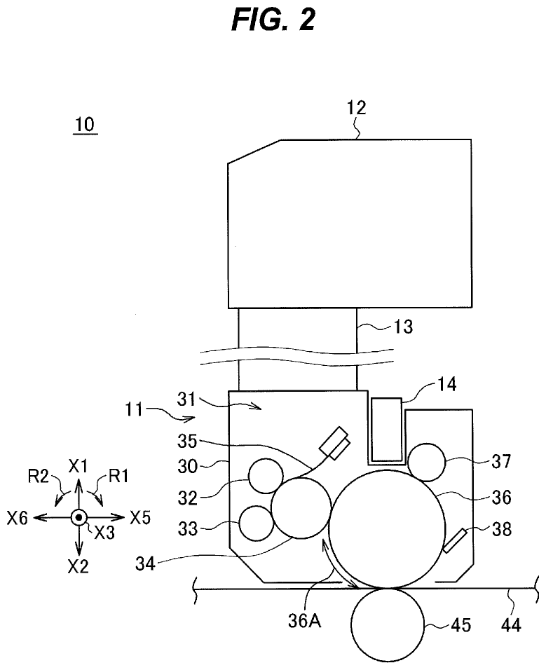

As illustrated in FIG. 2, each of the image forming units 10 is roughly constituted by an image forming main portion 11, a developer container 12, a developer supply portion 13, and a light emitting diode (LED) head 14. The image forming unit 10 and its parts have sufficient lengths in the left-right direction corresponding to the length of the sheet P in the left-right direction. Thus, many of the parts are longer in the left-right direction than in the front-rear direction and up-down direction, and formed in shapes elongated in the left-right direction.

The developer container 12 contains developer, and is configured to be attachable to and detachable from the image forming unit 10. When the developer container 12 is attached to the image forming unit 10, it is attached to the image forming main portion 11 via the developer supply portion 13.

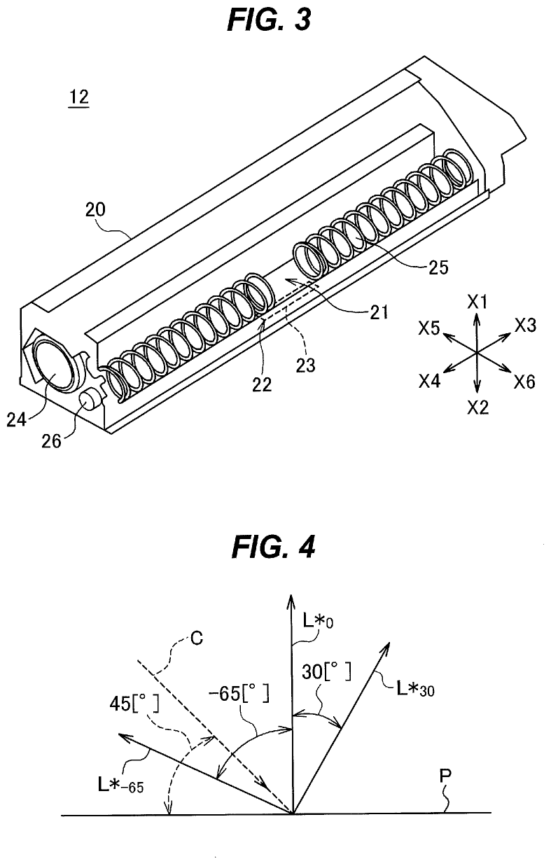

As illustrated in FIG. 3, the developer container 12 includes a container housing 20 elongated in the left-right direction. A storage chamber 21 as a storage portion, which is a cylindrical chamber extending in the left-right direction, is formed in the container housing 20. The storage chamber 21 contains the developer. The developer container 12 may be referred to as a toner cartridge.

Substantially at a center of a bottom of the storage chamber 21 in the left-right direction, a supply opening 22 through which a space in the storage chamber 21 communicates with the external space is formed, and a shutter 23 that opens and closes the supply opening 22 is provided. The shutter 23 is connected to a lever 24, and opens or closes the supply opening 22 in accordance with rotation of the lever 24. The lever 24 is operated by a user when the developer container 12 is attached to or detached from the image forming unit 10.

For example, in a state in which the developer container 12 is not attached to the image forming unit 10 (in FIG. 2), the shutter 23 closes the supply opening 22 and prevents the developer contained in the storage chamber 21 from leaking to the outside. When the developer container 12 is attached to the image forming unit 10, the lever 24 is rotated in a predetermined opening direction, thereby moving the shutter 23 to open the supply opening 22. This makes the space in the storage chamber 21 communicate with a space in the developer supply portion 13, and the developer in the storage chamber 21 of the developer container 12 is supplied to the image forming main portion 11 through the developer supply portion 13. Also, when the developer container 12 is detached from the image forming unit 10, the lever 24 is rotated in a predetermined closing direction, thereby moving the shutter 23 to close the supply opening 22.

Also, an agitator 25 is disposed in the storage chamber 21. The agitator 25 is formed in a shape such that an elongated member is spiraled about an imaginary central axis extending in the left-right direction, and is rotatable about the imaginary central axis in the storage chamber 21. An agitator driver 26 is disposed at an end of the container housing 20. The agitator driver 26 is connected to the agitator 25. When the agitator driver 26 is supplied with a driving force from a predetermined drive source disposed in the housing 2 (see FIG. 1), it transmits the driving force to the agitator 25 and rotates the agitator 25. Thereby, the developer container 12 can agitate the developer contained in the storage chamber 21, and prevent the developer from aggregating and feed the developer to the supply opening 22.

The image forming main portion 11 (see FIG. 2) includes an image forming housing 30, a developer storage space 31, a first supply roller 32, a second supply roller 33, a developing roller 34, a developing blade 35, a photosensitive drum 36, a charging roller 37, and a cleaning blade 38. The first supply roller 32, second supply roller 33, developing roller 34, photosensitive drum 36, and charging roller 37 are each formed in a cylindrical shape having a central axis extending in the left-right direction and rotatably supported by the image forming housing 30.

In the image forming unit 10S for the special color (S), the developer container 12 containing a silver developer is attached to the image forming main portion 11 via the developer supply portion 13.

The developer storage space 31 contains the developer supplied from the developer container 12 via the developer supply portion 13. The first supply roller 32 and second supply roller 33 each includes an elastic layer that is formed by conductive urethane rubber foam or the like and forms a periphery of the roller. The developing roller 34 includes an elastic layer, a conductive surface layer, or the like forming a periphery of the roller. The developing blade 35 is formed by, for example, a stainless steel sheet having a predetermined thickness, and a part of the developing blade 35 abuts the periphery of the developing roller 34 with the developing blade 35 slightly elastically deformed.

The photosensitive drum 36 includes a thin-film charge generation layer and a thin-film charge transport layer that are sequentially formed and form a periphery of the drum, and is chargeable. The charging roller 37 includes a conductive elastic body that forms a periphery of the roller. The periphery of the charging roller 37 abuts the periphery of the photosensitive drum 36. The cleaning blade 38 is formed by, for example, a thin-plate-shaped resin member, and a part of the cleaning blade 38 abuts the periphery of the photosensitive drum 36 with the cleaning blade 38 slightly elastically deformed.

The LED head 14 is located above the photosensitive drum 36 in the image forming main portion 11. The LED head 14 includes multiple light emitting element chips arranged linearly in the left-right direction, and causes light emitting elements of the light emitting element chips to emit light in a light emitting pattern based on an image data signal supplied from the controller 3 (see FIG. 1).

The image forming main portion 11 is supplied with a driving force from a motor (not illustrated), thereby rotating the first supply roller 32, second supply roller 33, developing roller 34, and charging roller 37 in the direction of arrow R1 (clockwise in FIG. 2) and rotating the photosensitive drum 36 in the direction of arrow R2 (counterclockwise in FIG. 2). Further, the image forming main portion 11 applies respective predetermined bias voltages to the first supply roller 32, second supply roller 33, developing roller 34, developing blade 35, and charging roller 37, thereby charging them.

Each of the first supply roller 32 and second supply roller 33 is charged to cause the developer in the developer storage space 31 to adhere to its periphery, and is rotated to apply the developer to the periphery of the developing roller 34. The developing blade 35 removes excess developer from the periphery of the developing roller 34 to form a thin layer of developer on the periphery. The periphery of the developing roller 34 with the thin layer of developer formed thereon is brought into contact with the periphery of the photosensitive drum 36.

The charging roller 37 abuts the photosensitive drum 36 while being charged, thereby uniformly charging the periphery of the photosensitive drum 36. The LED head 14 emits light at predetermined time intervals in a light emitting pattern based on an image data signal supplied from the controller 3 (see FIG. 1), thereby sequentially exposing the photosensitive drum 36. Thereby, an electrostatic latent image is sequentially formed on the periphery of the photosensitive drum 36, in the vicinity of the upper end of the photosensitive drum 36.

Then, rotation of the photosensitive drum 36 in the direction of arrow R2 brings the part with the electrostatic latent image formed thereon into contact with the developing roller 34. Thereby, developer adheres to the periphery of the photosensitive drum 36 based on the electrostatic latent image, thereby forming a developer image based on the image data. Further, rotation of the photosensitive drum 36 in the direction of arrow R2 brings the developer image to the vicinity of the lower end of the photosensitive drum 36.

An intermediate transfer unit 40 is disposed below the image forming units 10 in the housing 2 (see FIG. 1). The intermediate transfer unit 40 includes a drive roller 41, a driven roller 42, a backup roller 43, an intermediate transfer belt 44, five primary transfer rollers 45, a secondary transfer roller 46, and a reverse bending roller 47. The drive roller 41, driven roller 42, backup roller 43, primary transfer rollers 45, secondary transfer roller 46, and reverse bending roller 47 are each formed in a cylindrical shape having a central axis extending in the left-right direction and rotatably supported by the housing 2.

The drive roller 41 is disposed behind and below the image forming unit 10S, and rotates in the direction of arrow R1 when being supplied with a driving force from a belt motor (not illustrated). The driven roller 42 is disposed in front of and below the image forming unit 10K.

The upper ends of the drive roller 41 and driven roller 42 are located at the same level as or slightly below the lower ends of the photosensitive drums 36 (see FIG. 2) of the respective image forming units 10. The backup roller 43 is disposed in front of and below the drive roller 41 and behind and below the driven roller 42.

The intermediate transfer belt 44 is an endless belt formed by a high-resistance plastic film, and is stretched around the drive roller 41, driven roller 42, and backup roller 43. Further, in the intermediate transfer unit 40, the five primary transfer rollers 45 are disposed under a part of the intermediate transfer belt 44 stretched between the drive roller 41 and the driven roller 42, more specifically, at positions directly under the five image forming units 10 and facing the photosensitive drums 36 with the intermediate transfer belt 44 therebetween. The primary transfer rollers 45 are applied with predetermined bias voltages.

The secondary transfer roller 46 is located directly under the backup roller 43 and urged toward the backup roller 43. Thus, in the intermediate transfer unit 40, the intermediate transfer belt 44 is sandwiched between the secondary transfer roller 46 and the backup roller 43. Also, the secondary transfer roller 46 is applied with a predetermined bias voltage. Hereinafter, the secondary transfer roller 46 and backup roller 43 will be collectively referred to as a secondary transfer unit 49.

The reverse bending roller 47 is located in front of and below the drive roller 41 and above and behind the backup roller 43, and urges the intermediate transfer belt 44 forward and upward. Thereby, the intermediate transfer belt 44 is tightly stretched around the rollers. Also, a reverse bending backup roller 48 is disposed in front of and above the reverse bending roller 47 with the intermediate transfer belt 44 therebetween.

The intermediate transfer unit 40 rotates the drive roller 41 in the direction of arrow R1 with a driving force supplied from the belt motor (not illustrated), thereby moving the intermediate transfer belt 44 in a direction along arrow E1. Also, each primary transfer roller 45 rotates in the direction of arrow R1 while being applied with a predetermined bias voltage. Thereby, the image forming belt 10 can transfer, onto the intermediate transfer belt 44, the developer images that have been brought to the vicinities of the lower ends of the peripheries of the photosensitive drums 36 (see FIG. 2) and sequentially superimpose the developer images of the respective colors. At this time, the developer images of the respective colors are superimposed on a surface of the intermediate transfer belt 44 sequentially from the developer image of silver (S) on the upstream side. The intermediate transfer unit 40 moves the intermediate transfer belt 44 to convey the developer images transferred from the respective image forming belt 10 to the vicinity of the backup roller 43.

A conveying path W, which is a path for conveying the sheet P, is formed in the housing 2 (see FIG. 1). The conveying path W extends forward and upward from the front side of the lower end of the housing 2, makes a half turn, and extends rearward under the intermediate transfer unit 40. Then, the conveying path W extends upward behind the intermediate transfer unit 40 and image forming unit 10S, and extends forward. Thus, the conveying path W is formed in an S-shape in FIG. 1. In the housing 2, various components are disposed along the conveying path W.

A first sheet feeder 50 is disposed in the housing 2 near the lower end of the housing (see FIG. 1). The first sheet feeder 50 includes a sheet cassette 51, a pickup roller 52, a feed roller 53, a retard roller 54, a conveying guide 55, pairs of conveying rollers 56, 57, and 58, and the like. The pickup roller 52, the feed roller 53, the retard roller 54, and the conveying rollers of the pairs 56, 57, and 58 are each formed in a cylindrical shape having a central axis extending in the left-right direction.

The sheet cassette 51 is formed in a hollow rectangular parallelepiped shape, and contains sheets P in a state in which the sheets P are stacked with their surfaces facing in the up-down direction, or in a stacked state. Also, the sheet cassette 51 is attachable to and detachable from the housing 2.

The pickup roller 52 abuts the uppermost surface of the sheets P contained in the sheet cassette 51, near the front end of the uppermost surface. The feed roller 53 is disposed in front of and at a distance from the pickup roller 52. The retard roller 54 is located under the feed roller 53 and forms a gap corresponding to the thickness of a sheet P between the retard roller 54 and the feed roller 53.

When the first sheet feeder 50 is supplied with a driving force from a sheet feed motor (not illustrated), it rotates or stops the pickup roller 52, feed roller 53, and retard roller 54 as appropriate. Thereby, the pickup roller 52 feeds forward one or more uppermost sheets of the sheets P contained in the sheet cassette 51. The feed roller 53 and retard roller 54 further feed forward the uppermost sheet of the sheets P while stopping the other sheets. In this manner, the first sheet feeder 50 separates and feeds forward the sheets P one by one.

The conveying guide 55 is disposed in a front lower part of the conveying path W, and allows the sheet P to move forward and upward and further move rearward and upward along the conveying path W. The pair of conveying roller 56 is disposed near a center of the conveying guide 55. The pair of conveying roller 57 is disposed near an upper end of the conveying guide 55. The pairs of conveying rollers 56 and 57 are supplied with driving forces from the sheet feed motor (not illustrated) to rotate in predetermined directions. Thereby, the pairs of conveying rollers 56 and 57 convey the sheet P along the conveying path W.

Also, a second sheet feeder 60 is disposed in front of the pair of conveying rollers 57 in the housing 2. The second sheet feeder 60 includes a sheet tray 61, a pickup roller 62, a feed roller 63, a retard roller 64, and the like. The sheet tray 61 is formed in the shape of a plate that is thin in the up-down direction, and has sheets P2 placed thereon. The sheets P2 placed on the sheet tray 61 are, for example, sheets different in size or quality from the sheets P contained in the sheet cassette 51.

The pickup roller 62, feed roller 63, and retard roller 64 are configured in the same manner as the pickup roller 52, feed roller 53, and retard roller 54 of the first sheet feeder 50, respectively. When the second sheet feeder 60 is supplied with a driving force from the sheet feed motor (not illustrated), it rotates and stops the pickup roller 62, feed roller 63, and retard roller 64 as appropriate, thereby feeding rearward the uppermost sheet of the sheets P2 on the sheet tray 61 while stopping the other sheets. In this manner, the second sheet feeder 60 separates and feeds rearward the sheets P2 one by one. The sheet P2 fed at this time is conveyed by the pair of conveying rollers 57 along the conveying path W similarly to the sheet P. Hereinafter, for convenience of description, sheets P2 will be simply referred to as sheets P without distinguishing sheets P2 from sheets P.

The rotation of the pair of conveying rollers 57 is controlled as appropriate. Thereby, the pair of conveying rollers 57 applies a frictional force to the sheet P to correct inclination of the sides of the sheet P relative to the moving direction, i.e., skew of the sheet P, and place the sheet P in a state in which leading and trailing edges of the sheet P are along the left-right direction, and then feeds the sheet P rearward. The pair of conveying rollers 58 is located behind and at a predetermined distance from the pair of conveying rollers 57. The pair of conveying rollers 58 rotates similarly to the pair of conveying rollers 56 and the like, thereby applying a driving force to the sheet P conveyed along the conveying path W and further conveying the sheet P rearward along the conveying path W.

The secondary transfer unit 49, i.e., the backup roller 43 and secondary transfer roller 46, of the intermediate transfer unit 40 is disposed behind the pair of conveying rollers 58. In the secondary transfer unit 49, the developer images that have been formed by the image forming belt 10 and transferred onto the intermediate transfer belt 44 approach the conveying path W with the movement of the intermediate transfer belt 44, and the secondary transfer roller 46 is applied with a predetermined bias voltage. Thus, the secondary transfer unit 49 transfers the developer images from the intermediate transfer belt 44 to the sheet P conveyed along the conveying path W and conveys the sheet P further rearward.

A fixing unit 70 is disposed behind the secondary transfer unit 49. The fixing unit 70 is constituted by a heating unit 71 and a pressure unit 72 that face each other with the conveying path W therebetween. The heating unit 71 includes a heating belt that is an endless belt, and components, such as a heater and multiple rollers, disposed inside the heating belt. The pressure unit 72 is formed in a cylindrical shape having a central axis extending in the left-right direction, and presses its upper surface against a lower surface of the heating unit 71 to form a nip portion.

The fixing unit 70 heats the heater of the heating unit 71 to a predetermined temperature and rotates a roller as appropriate to rotate the heating belt in the direction of arrow R1, and rotates the pressure unit 72 in the direction of arrow R2, under control of the controller 3. In this state, when the fixing unit 70 receives the sheet P on which the developer images have been transferred by the secondary transfer unit 49, it nips the sheet P with the heating unit 71 and pressure unit 72, fixes the developer images to the sheet P by applying heat and pressure, and feeds it rearward.

A pair of conveying rollers 74 is disposed behind the fixing unit 70, and a switch 75 is disposed behind the pair of conveying rollers 74. The switch 75 switches the traveling direction of the sheet P to an upward direction or a downward direction, under control of the controller 3. A sheet discharge unit 80 is disposed above the switch 75. The sheet discharge unit 80 includes a conveying guide 81 that guides the sheet P upward along the conveying path W, pairs of conveying rollers 82, 83, 84, and 85 facing each other with the conveying path W therebetween, and the like.

A reconveying unit 90 is disposed below the switch 75, fixing unit 70, secondary transfer unit 49, and the like. The reconveying unit 90 includes a conveying guide and pairs of conveying rollers (not illustrated) that form a reconveying path U, and the like. The reconveying path U extends downward from below the switch 75, extends forward, and then joins the conveying path W on the downstream side of the pair of conveying rollers 57.

When the sheet P is discharged, the controller 3 switches the traveling direction of the sheet P to a direction toward the sheet discharge unit 80, which is the upward direction, by means of the switch 75. The sheet discharge unit 80 conveys the sheet P received from the switch 75 upward, and discharges it to a sheet discharge tray 2T through an outlet 86. Also, when the sheet P is returned, the controller 3 switches the traveling direction of the sheet P to a direction toward the reconveying unit 90, which is the downward direction, by means of the switch 75. The reconveying unit 90 conveys the sheet P received from the switch 75 along the reconveying path U to the downstream side of the pair of conveying rollers 57 and causes the sheet P to be reconveyed along the conveying path W. Thereby, the sheet P is inverted and returned to the conveying path W, which allows the image forming apparatus 1 to perform duplex printing.

As described above, the image forming apparatus 1 forms developer images using the developers in the image forming belt 10, transfers the developer images onto the intermediate transfer belt 44, transfers the developer images from the intermediate transfer belt 44 onto a sheet P in the secondary transfer unit 49, and fixes the developer images in the fixing unit 70, thereby printing (or forming) an image on the sheet P.

### 2. PRODUCTION OF DEVELOPER

Next, production of the developers contained in the developer containers 12 of the image forming belt 10 (see FIG. 2) will be described. In this embodiment, production of the silver developer will be described especially.

In general, developer contains a pigment for exhibiting a desired color, a binder resin for binding the pigment to a medium, such as a sheet P, an external additive for improving the chargeability, and the like. Hereinafter, for convenience of description, a particle containing a pigment and a binder resin will be referred to as a toner base particle (or toner particle), and powder containing toner base particles will be referred to as developer D. Developer D may contain an external additive or the like. Developer D is also referred to as toner.

Different types of developers D having different configurations and properties were produced by varying the production conditions. Hereinafter, developers D produced in Example 1, Example 2, Example 3, Example 4, Example 5, Comparative Example 1, Example 6, and Example 7 will be referred to as developers Da, Db, Dc, Dd, De, Df, Dg, and Dh, respectively.

### 2-1. EXAMPLE 1

In Example 1, an aqueous medium with an inorganic dispersant dispersed therein was first prepared.

Specifically, 919 parts by weight of industrial trisodium phosphate dodecahydrate was mixed with 26526 parts by weight of pure water, and dissolved therein at a liquid temperature of 60° C. Then, the resulting liquid was added with dilute nitric acid for pH (hydrogen-ion exponent) adjustment. The resulting aqueous solution was added with an aqueous calcium chloride solution obtained by dissolving 443 parts by weight of industrial calcium chloride anhydride in 4504 parts by weight of pure water, and was high-speed stirred with a Line Mill (manufactured by Primix Corporation) at a rotation speed of 3566 rpm for 34 minutes while being maintained at a liquid temperature of 60° C. Thereby, an aqueous phase that is an aqueous medium with a suspension stabilizer (or inorganic dispersant) dispersed therein was prepared.

Also, in Example 1, a pigment dispersion oil medium was prepared. Specifically, a pigment dispersion liquid was prepared by mixing 394 parts by weight of a brilliant pigment (having an average thickness of 0.5 μm, an average short side of 8 μm, and an average long side of 12 μm) and 59 parts by weight of a charge control agent (BONTRON E-84, manufactured by Orient Chemical Industries Co., Ltd.) with 7427 parts by weight of ethyl acetate. The brilliant pigment contains fine aluminum (Al) flakes, or aluminum small pieces formed in flat plate shapes, flat shapes, or scale shapes. Hereinafter, the brilliant pigment will also be referred to as an aluminum pigment, a metallic pigment, or a silver toner pigment. In this case, an average particle size (also referred to as volume median size, volume median particle size, average median size, or pigment particle size) of the brilliant pigment is preferably not less than 5 μm and not more than 20 μm. The reason thereof will be described below.

It is known that when the volume median size of a brilliant pigment is less than 5 μm, the brilliance of the developer is accordingly low, leading to low image brilliance and low image quality. On the other hand, it is known that when the volume median size of a brilliant pigment is more than 20 μm, it is difficult to include or enclose brilliant pigment particles in toner base particles, and it is difficult to form developer. Even if developer can be formed using such a brilliant pigment, it is difficult to convey the developer in an image forming apparatus, and it is difficult to properly form an image.

The average particle size of the brilliant pigment was measured by using a digital microscope (VH-5500, manufactured by Keyence Corporation) and a lens (VH-500, manufactured by Keyence Corporation) as follows. The brilliant developer was dispersed in a surfactant (EMULGEN 109P, manufactured by Kao Corporation). The resulting liquid was dropped on a glass slide, covered by a cover glass, and observed with the digital microscope at a magnification of 1000 times by transmission illumination. By taking advantage of the fact that the particles (or flakes) of the brilliant pigment block light and look black, longitudinal sizes (or dimensions) of 50 particles of the brilliant pigment contained in the brilliant developer were measured, and an average of the measured sizes was obtained as the average particle size.

Then, the pigment dispersion liquid was stirred while being maintained at a liquid temperature of 60° C., and added with 59 parts by weight of a charge control resin (FCA-726N, manufactured by Fujikura Kasei Co., Ltd.), 148 parts by weight of an ester wax (WE-4, manufactured by NOF Corporation) as a release agent, and 1311 parts by weight of polyester resin as a binder resin. The mixture was stirred until solid dissolved. Thereby, an oil phase that is a pigment dispersion oil medium was prepared.

Then, the oil phase was added to the aqueous phase maintained at a liquid temperature of 60° C., and suspended by stirring for a granulation time of 13.5 minutes at a rotation speed of 900 rpm at a flow rate of 53.0 kg/min, so that particles were formed in a suspension liquid. The granulation time, rotation speed, and flow rate were granulation conditions. Then, the ethyl acetate was removed by distilling the suspension liquid under reduced pressure, so that a slurry containing the particles was formed. Then, the slurry was added with nitric acid so that the pH (hydrogen-ion exponent) of the slurry was adjusted to 1.6 or lower, and was stirred. Tricalcium phosphate as a suspension stabilizer was dissolved therein, and the mixture was dehydrated, so that dehydrated particles were obtained. Then, the dehydrated particles were re-dispersed in pure water, stirred, and water-washed. After that, through dehydration, drying, and classification processes, toner base particles were obtained.

Then, in an external addition process, the toner base particles thus obtained were added and mixed with 1.5 wt % of small silica (AEROSIL RY200, manufactured by Nippon Aerosil Co., Ltd.), 2.29 wt % of colloidal silica (X-24-9163A, manufactured by Shin-Etsu Chemical Co., Ltd.), and 0.37 wt % of melamine particles (EPOSTAR S, manufactured by NIPPON SHOKUBAI CO., LTD.), so that developer Da was obtained.

### 2-2. EXAMPLES 2 to 5

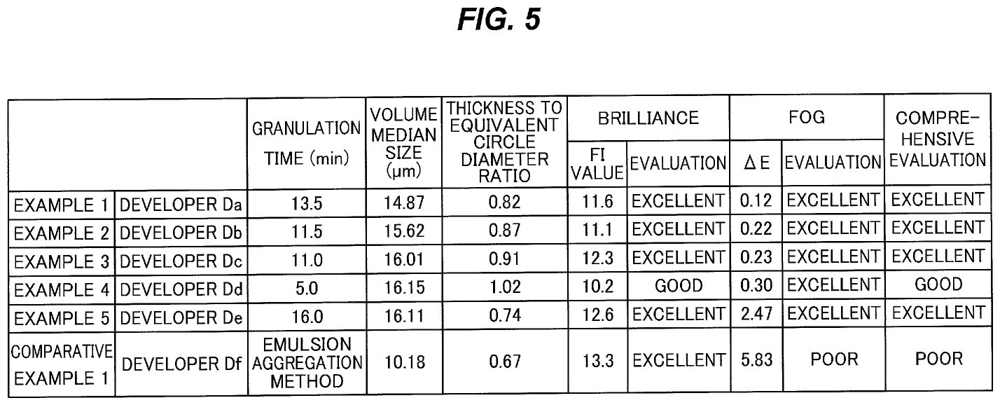

In Examples 2, 3, 4, and 5, developers Db, Dc, Dd, and De were obtained in the same manner as developer Da in Example 1 except that the granulation time was varied, as shown in FIG. 5.

### 2-3. COMPARATIVE EXAMPLE 1

In Comparative Example 1, developer Df was obtained by the following emulsion aggregation method, with Example 1 as a reference. Unless otherwise specified, the materials and additive amounts are the same as those in Example 1.

### 2-3-1. PREPARATION OF POLYESTER RESIN DISPERSION LIQUID

In Comparative Example 1, a polyester resin dispersion liquid was first prepared. Specifically, 3000 parts by weight of polyester resin, 7000 parts by weight of ion exchanged water, and 90 parts by weight of surfactant sodium dodecylbenzene sulfonate were put into an emulsification tank of a high-temperature and high-pressure emulsifier (CAVITRON CD1010, manufactured by Eurotech Co., Ltd., slit: 0.4 mm), heated to 130° C. and melted. Then, the resultant was dispersed at a flow rate of 3 L/m at 110° C. at 10000 rpm for 30 minutes and passed through a cooling tank, and thereby a polyester resin dispersion liquid (having a solid content concentration of 30 wt %) was prepared.

### 2-3-2. PREPARATION OF RELEASE AGENT DISPERSION LIQUID

Also, in Comparative Example 1, a release agent dispersion liquid was prepared.

Specifically, 50 parts by weight of wax, 1.0 parts by weight of an anionic surfactant (NEOGEN RK, manufactured by DKS Co., Ltd.), and 200 parts by weight of ion exchanged water were put into a pressure container, heated to 110° C. while being stirred, and subjected to a dispersion treatment 10 times (or 10 passes) with a high-pressure homogenizer. Thereby, a release agent dispersion liquid having a solid content concentration of 20 wt % was prepared.

### 2-3-3. PREPARATION OF FIRST AGGREGATED PARTICLE DISPERSION LIQUID OF METALLIC PIGMENT

Also, in Comparative Example 1, a first aggregated particle dispersion liquid of metallic pigment (also referred to as a brilliant pigment dispersion liquid or a pigment particle slurry) was prepared. Specifically, 360 parts by weight of ion exchanged water and 0.5 parts by weight of an anionic surfactant (NEOGEN RK, manufactured by DKS Co., Ltd.) were weighed and put into a 3-L cylindrical stainless container. Then, 20 parts by weight of a brilliant pigment was added thereto, well wetted by stirring, and then dispersed and mixed for 1 minute with a homogenizer (ULTRA-TURRAX T50, manufactured by IKA). Then, the resultant was added with 1.25 parts by weight of a 1 wt % aqueous solution of aluminum sulfate as an aggregating agent, and further dispersed and mixed for 1 minute. Thereby, a first aggregated particle dispersion liquid of metallic pigment (or pigment particle slurry) was prepared.

### 2-3-4. PREPARATION OF TONER BASE PARTICLES

### 2-3-4-1. AGGREGATION PROCESS

A stirrer and a thermometer are placed in the 3-L cylindrical stainless container, and the content was gradually heated with a mantle heater while being continuously stirred to be homogenized, and added with a mixture consisting of 55 parts by weight of ion exchanged water, 210 parts by weight of the polyester resin dispersion liquid, and 20 parts by weight of the release agent dispersion liquid in several batches and then added with a mixture consisting of 55 parts by weight of ion exchanged water and 210 parts by weight of the polyester resin dispersion liquid while being maintained at 45° C., so that the polyester resin and release agent adhered to the surfaces of the pigment particles in the pigment particle slurry and the pigment particles grew to second aggregated particles having a volume average particle size of 10.5 μm. Observation of the second aggregated particles under an optical microscope showed that particle layers were formed on the surfaces of the pigment particles in such a manner that resin particles and release agent particles were aggregated to form the particle layers.

### 2-3-4-2. FUSION PROCESS

Then, the progress of aggregation of the second aggregated particles was stopped by adjusting the pH of the dispersion liquid containing the second aggregated particles (or an aggregated particle slurry) to 9.0, and a toner slurry was obtained by raising the liquid temperature to 80° C., and maintaining the state for a fusion time of 3 hours and cooling it while checking the degree of fusion under an optical microscope.

After that, the toner slurry was subjected to washing, dehydration, drying, classification, and external addition processes in the same manner as in Example 1, so that developer Df was obtained.

In this embodiment, aluminum is used as the brilliant pigment contained in the brilliant developer, and aluminum flakes are included in the toner base particles, which are bases of the developer. Depending on the content of aluminum in the brilliant developer, color images formed by the image forming unit 10 may have poor image quality. Since aluminum is a metal material having high conductivity, the aluminum flakes facilitate escape of charges from the developer when the developer is charged, and may prevent the developer from being charged sufficiently. If the average particle size of the aluminum flakes is large, it is difficult to include or enclose the aluminum flakes in the toner base particles, and some aluminum flakes may be exposed. This further facilitates escape of charges from the developer, leading to insufficient charge of the developer. When the charge amount of the developer is small, fog (to be described later) occurs, degrading the image quality. So it is conceivable to reduce the content of aluminum in the developer. However, this reduces the image brilliance and degrades the image quality. It is also conceivable to reduce the average particle size of the brilliant pigment. However, this accordingly reduces the brilliance of the developer and degrades the image quality. Thus, it is an important issue specific to brilliant developers to achieve both prevention of fog due to insufficient charge of developer and provision of high brilliance. Thus, in this embodiment, various types of brilliant developers produced by the dissolution suspension method are used.

### 2-4. EXAMPLES 6 AND 7

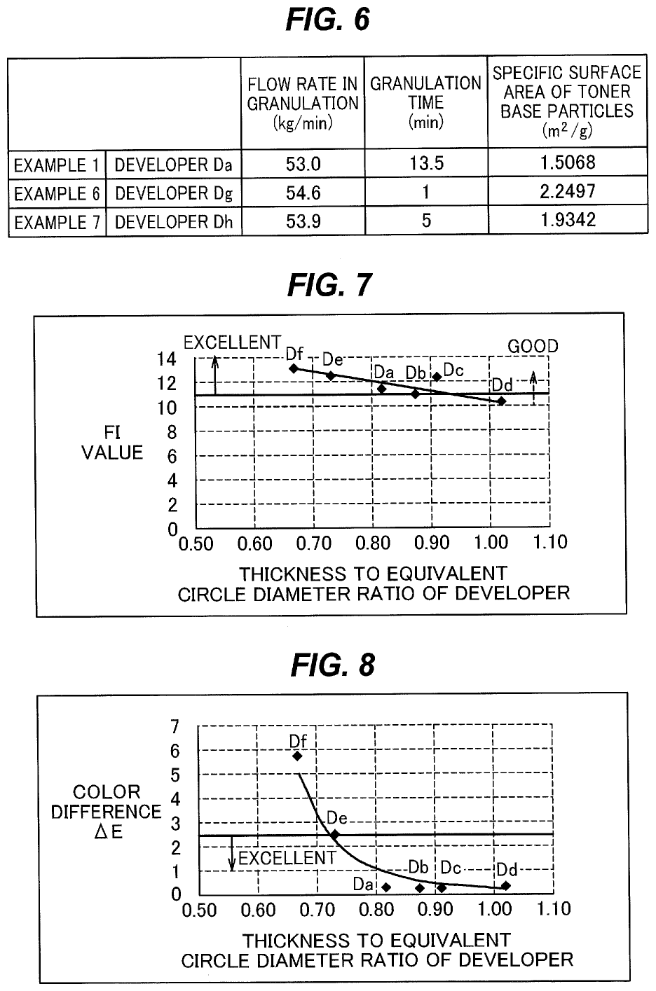

In Examples 6 and 7, developers Dg and Dh were obtained in the same manner as developer Da in Example 1 except that the granulation time and flow rate in the granulation were varied as shown in FIG. 6.

### 3. MEASUREMENTS AND COMPARISONS OF DEVELOPERS

Next, measurements and evaluations of the developers D (i.e., developers Da, Db, Dc, Dd, De, Df, Dg, and Dh, which will also be referred to below as developers Da to Dh) will be described. For each of developers Da, Db, Dc, Dd, De, and Df, a developer particle size, which is a volume median size (Dv50), and a thickness to equivalent circle diameter ratio were measured. Also, each of developers Da, Db, Dc, Dd, De, and Df was evaluated for brilliance and fog by printing predetermined images on sheets P with the developer D by using the image forming apparatus 1 (see FIG. 1). For each of developers Da, Dg, and Dh, a specific surface area (BET value) of the toner base particles (or a base material) was measured. Also, each of developers Da, Dg, and Dh was evaluated for vertical streaks. Further, for each of the developers D, the silica content was measured. Further, the developers D were measured by observing cross-sections of the developers D.

### 3-1. MEASUREMENT OF VOLUME MEDIAN SIZE

In this measurement, the volume median size (also referred to as volume average particle size) of each of developers Da, Db, Dc, Dd, De, and Df was measured by using an accurate particle size distribution analyzer (Multisizer 3, manufactured by Beckman Coulter, Inc.) under the following measurement conditions:

Aperture diameter: 100 μm

Electrolyte: ISOTON II (manufactured by Beckman Coulter, Inc.)

Dispersion liquid: a liquid obtained by dissolving NEOGEN S-20F (manufactured by DKS Co., Ltd.) in the above electrolyte and adjusting the concentration to 5%

In this measurement, 10 to 20 mg of the measurement sample was added to 5 ml of the dispersion liquid, dispersed with an ultrasonic disperser for 1 minute, added with 25 ml of the electrolyte, dispersed with the ultrasonic disperser for 5 minutes, and passed through a mesh having an opening size of 75 μm to remove aggregates, so that a sample dispersion liquid was prepared.

Further, in this measurement, the sample dispersion liquid was added to 100 ml of the electrolyte, and the volume particle size distribution was obtained by measuring 30000 particles with the accurate particle size distribution analyzer. Then, in this measurement, the volume median size (Dv50) was determined on the basis of the volume particle size distribution.

The volume median size (Dv50) refers to the particle size at which the cumulative volume percentage is 50%. The accurate particle size distribution analyzer measures the particle size distribution based on the Coulter principle. The Coulter principle is a method, called aperture electrical resistance method, of measuring the volume of a particle by passing a constant current through an aperture in an electrolyte solution and measuring a change in the electrical resistance across the aperture when the particle passes through the aperture.

With this measurement, the volume median size of each of developers Da to Df was measured. The measurement results are shown in the table of FIG. 5.

### 3-2. MEASUREMENT OF THICKNESS TO EQUIVALENT CIRCLE DIAMETER RATIO

In this measurement, for each of developers Da, Db, Dc, Dd, De, and Df, a thickness to equivalent circle diameter ratio of the developer was calculated as a flatness of the developer by measuring a thickness and an equivalent circle diameter of the developer. The procedure of the measurement was as follows.

First, an amount of the developer was placed on a glass slide, and evenly dispersed by applying vibration. The thickness to equivalent circle diameter ratio was calculated by measuring, for each of 100 toner base particles, a maximum thickness and an equivalent circle diameter as viewed from above of the toner base particle at a magnification of 2000 times with the above-described digital microscope and lens, obtaining an arithmetic average of the maximum thicknesses and an arithmetic average of the equivalent circle diameters, and dividing the arithmetic average of the maximum thicknesses by the arithmetic average of the equivalent circle diameters.

With this measurement, the thickness to equivalent circle diameter ratio of each of developers Da to Df was measured. The measurement results are shown in the table of FIG. 5. FIG. 5 shows that the longer the granulation time, the smaller the thickness to equivalent circle diameter ratio, i.e., the flatter the toner base particles. This is because shearing forces applied to droplets of the oil phase increase and thereby oil phase components of the surfaces of the droplets are separated. The more the oil phase components of the surfaces of the droplets are separated, the thinner the layers of the oil phase covering the surfaces of the metallic pigment particles become. Thus, the shapes of the toner base particles approach those of the metallic pigment particles and become flatter.

### 3-3. MEASUREMENT OF SPECIFIC SURFACE AREA

In this measurement, the specific surface area of the toner base particles before the external addition of each of developers Da, Dg, and Dh was measured with a micromeritics automatic surface area and porosimetry analyzer (TRISTAR-3000, manufactured by Shimadzu Corporation).

The results of the measurements of the specific surface area of the toner base particles of each of developers Da, Dg, and Dh are shown in the table of FIG. 6. FIG. 6 shows that the shorter the granulation time, or the greater the flow rate in the granulation, the greater the specific surface area of the toner base particles (or base material). The reason is presumed as follows. As the granulation time decreases, the shearing force applied to an oil phase droplet decreases as described above, and thus the amount of oil phase covering the metallic pigment increases. As the amount of oil phase covering the metallic pigment increases, the surface shape changes more easily, and thus the surface area can increase. Also, in the granulation, an oil phase droplet repeatedly collides with wall surfaces and other oil phase droplets while moving through piping and thereby is subjected to stress from different directions. As the flow rate increases, the stress increases, and thus the arrangement of metallic pigment particles included in the droplet tends to become more random. The shape of a droplet is determined by the oil phase covering the metallic pigment.

Thus, compared to a droplet with metallic pigment particles arranged in the same direction, a droplet with metallic pigment particles arranged randomly is thicker and thus greater in surface area.

### 3-4. MEASUREMENT OF SILICA CONTENT

In this measurement, for each of developers Da to Dh, the silica content (i.e., the amount of the external additive) of the developer D was measured. Specifically, in this measurement, the developer D was irradiated with X-rays emitted from an X-ray tube by using an energy dispersive X-ray fluorescence spectrometer (EDX-800HS, manufactured by Shimadzu Corporation), and the silicon (Si) content in the developer D was determined on the basis of fluorescent X-rays emitted from atoms of silicon (Si) (or silica) contained in the developer D. The energy dispersive X-ray fluorescence spectrometer was used under the following conditions:

Atmosphere: Helium replacement measurement

X-ray tube voltage: 15kV, 50kV

The developers D of the embodiment contained multiple types of silica as the external additive, and the silica contents detected by the elemental analysis of the developers D with the energy dispersive X-ray fluorescence spectrometer were in the range of 2.200 to 2.300 wt %.

### 3-5. EVALUATION OF BRILLIANCE

In this evaluation, for each of developers Da to Df, after the developer D was put in the developer container 12 (see FIG. 2) of the image forming unit 10S corresponding to the special color of the image forming apparatus 1 (C941dn, manufactured by Oki data Corporation) (see FIG. 1), a printing process was performed in a special color white mode using silver developer, and a brilliance evaluation was performed.

Specifically, in this evaluation, an image pattern having a print image density of 100% (or a solid image) was printed on a coated paper (OS coated paper W, having a basis weight of 127 g/m², manufactured by Fuji Xerox Co., Ltd.) as a sheet P by using the image forming apparatus 1. At this time, the printing process was performed in a state in which the image forming apparatus 1 had been adjusted by performing an operation for setting printing conditions so that the amount of the developer D deposited on the photosensitive drum 36 of the image forming unit 10S (see FIG. 2) was 1.0 mg/cm². Unless otherwise specified, print image evaluations described below were performed under the same conditions.

Here, the print image density refers to a value indicating, when an image is divided into pixels, the percentage of the number of pixels at which the developer D is transferred onto the sheet P to the total number of the pixels. For example, when a solid image is printed on the entire printable area of a predetermined region (such as the outer periphery of the photosensitive drum 36 or a surface of a print medium), or when printing is performed at a coverage rate of 100%, the print image density is 100%; when an image is printed on 1% of the printable area, or when printing is performed at a coverage rate of 1%, the print image density is 1%. The print image density DPD can be expressed by the following equation (1):

$$DPD = \frac{C m}{C d \times C O} \times 100 \qquad ( 1 )$$

where Cd is the number of revolutions of the photosensitive drum 36, Cm is the number of dots actually used to form an image while the photosensitive drum 36 makes Cd revolutions and is the total number of dots exposed by the LED head 14 (see FIG. 2) while the image is formed, and CO is the total number of dots per revolution of the photosensitive drum 36 (see FIG. 2), i.e., the total number of dots that can be potentially used for image formation during one revolution of the photosensitive drum 36 regardless of whether they are actually exposed. In other words, CO is the total number of dots used in formation of a solid image in which the developer D is transferred onto all the pixels. Thus, the value Cd×CO represents the total number of dots that can be potentially used for image formation during Cd revolutions of the photosensitive drum 36.

Then, in this evaluation, the brilliance of the printed image was measured by using a variable angle photometer (GC-5000L, manufactured by Nippon Denshoku Industries Co., Ltd.). Specifically, as illustrated in FIG. 4, with the variable angle photometer, the sheet P was illuminated with a light ray C at an angle of 45° relative to the surface of the sheet P, light reflected by the sheet P was received at angles 0°, 30°, and −65° relative to the direction perpendicular to the surface of the sheet P, and lightness indexes L*₀, L*₃₀, and L*₋₆₅ were respectively calculated from the light reception results obtained at 0°, 30°, and −65°. Then, in this evaluation, the brilliance of the image was determined by calculating a flop index FI by substituting the calculated lightness indexes into the following equation (2):

$$FI = 2.69 \times \frac{{( L {*}_{30} - L {*}_{- 65} )}^{1.11}}{{( L {*}_{0} )}^{0.86}} . \qquad ( 2 )$$

A higher value of the flop index FI indicates a higher brilliance, and a lower value of the flop index FI indicates a lower brilliance. In this evaluation, when the flop index FI was 10 or more, it was evaluated that the printed product had metallic luster, the image brilliance was high, and the print quality was high. When the flop index FI was 11 or more, it was evaluated that the image brilliance was higher, and the print quality was higher. When the flop index FI was less than 10, it was evaluated that the printed product had low metallic luster, the image brilliance was low, and the print quality was low. FIG. 7 shows the relationship between the thickness to equivalent circle diameter ratios of the developers and the FI values obtained in this evaluation.

Also, FIG. 5 shows the calculated values of the flop index FI and evaluation results in this evaluation. When the flop index FI was not less than 11, the brilliance was rated as “excellent”, and when the flop index FI was not less than 10 and less than 11, the brilliance was rated as “good”.

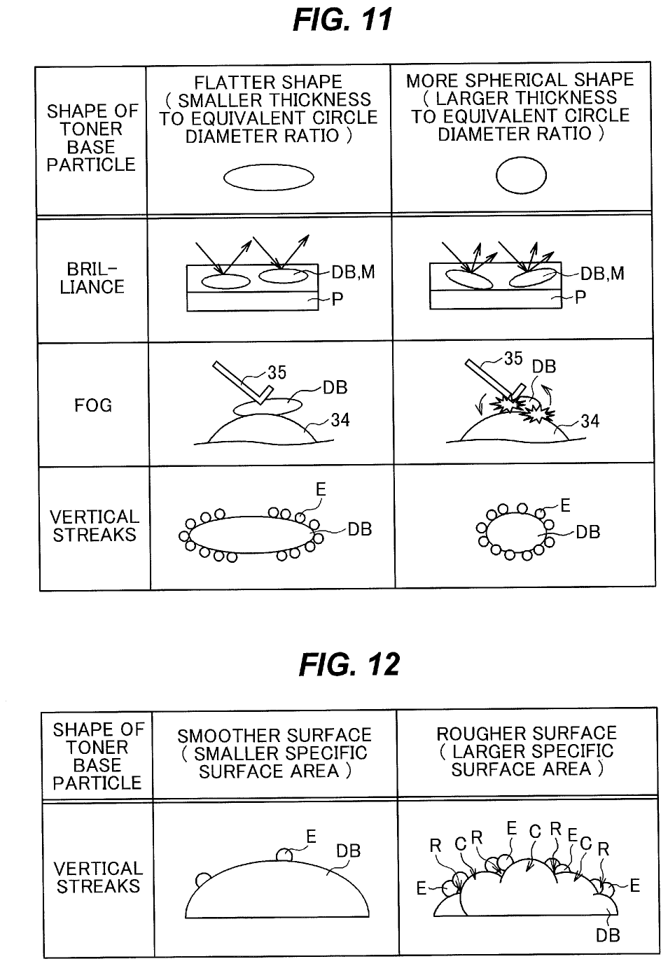

FIG. 5 shows that when the thickness to equivalent circle diameter ratio is not more than 1.02, the FI value is good, and when the thickness to equivalent circle diameter ratio is not more than 0.91, the FI value is excellent. This is because the smaller the thickness to equivalent circle diameter ratio, the flatter the shapes of the toner base particles of the developer D. As illustrated on the left side of the row of “brilliance” of FIG. 11, as the thickness to equivalent circle diameter ratio of the developer D decreases and the toner base particles DB of the developer D become flatter, the toner base particles DB transferred on the sheet P become more likely to be arranged parallel to the sheet P. Thus, also in the printed image after the fixing, the metallic pigment particles M, which are flat, included in the toner base particles DB also become more likely to be arranged parallel to the sheet P. This increases the specular reflectance, thus increasing the brilliance. Conversely, as illustrated on the right side of the row of “brilliance” of FIG. 11, as the thickness to equivalent circle diameter ratio of the developer D increases and the toner base particles DB of the developer D become more spherical, the toner base particles DB and metallic pigment particles M of the developer D transferred on the sheet P become less likely to be arranged parallel to the sheet P. Thus, also in the printed image after the fixing, the metallic pigment particles M, which are flat, included in the toner base particles DB also become less likely to be arranged parallel to the sheet P. This increases the diffuse reflectance and decreases the specular reflectance, thus decreasing the brilliance.

### 3-6. EVALUATION OF FOG

In this evaluation, for each of developers Da to Df, after the developer D was put in the developer container 12 (see FIG. 2) of the image forming unit 10S corresponding to the special color of the image forming apparatus 1 (C941dn, manufactured by Oki data Corporation) (see FIG. 1), a printing process was performed, and a fog evaluation was performed.

In this embodiment, a phenomenon in which toner particles charged less than or opposite in polarity to normally charged toner particles adhere to a background portion or a non-image portion of an image will be referred to as “fog”. Also, in this embodiment, toner particles (specifically, less charged toner particles or oppositely charged toner particles) causing fog will be referred to as “fog toner particles”.

Specifically, the fog refers to a phenomenon in which oppositely charged toner particles on the developing roller 34 are electrically transferred onto a non-exposed portion of the photosensitive drum 36 and printed on a white background. This is an important issue in brilliant developers that contain brilliant pigments, which are metallic materials, and thus tend to be insufficiently charged. The same thing can be said in terms of media used in printing. Specifically, the metallic pigment particles of a brilliant developer need to be arranged parallel to a medium, in order to enhance the brilliance, which is the main feature of the brilliant developer. At this time, as the print medium becomes smoother, the metallic pigment particles become more likely to be arranged parallel to the medium, and thus can provide higher brilliance. Thus, in printing with a brilliant developer, it is common to use a smooth medium. However, a smooth medium makes fog toner particles (oppositely charged toner particles transferred on a white background portion) more noticeable. This is because a smooth medium allows developer to melt and spread easily (or widely) in fixing of the developer to the medium, which increases the brilliance of fog toner particles when the developer is brilliant developer. Thus, for brilliant developers requiring use of metallic pigments and smooth media, fog is one of the important quality factors.

Specifically, in this evaluation, after starting a printing process of an image pattern having a print image density of 0%, or an image such that no developer D is used at all the pixels, the printing process was stopped in the middle of the developing process in the image forming unit 10S (see FIG. 2), i.e., the process of transferring developer D from the surface of the developing roller 34 to the surface of the photosensitive drum 36.

Then, in this evaluation, fog toner particles were taken by applying a piece of adhesive tape (Scotch Mending Tape, manufactured by Sumitomo 3M Ltd.) to the surface of the photosensitive drum 36 and then peeling it off, on the downstream side of a portion where the photosensitive drum 36 abuts the developing roller 34 and on the upstream side of a portion where the photosensitive drum 36 abuts the intermediate transfer belt 44, specifically in region 36A in FIG. 2. Hereinafter, the piece of adhesive tape will be referred to as the sampling adhesive tape piece.

Then, in this evaluation, the sampling adhesive tape piece was attached to a white paper sheet (Excellent White A4, being 70 kg paper, having a basis weight of 80 g/m², manufactured by Oki Data Corporation), and a piece of adhesive tape serving as a reference for comparison (referred to below as the reference adhesive tape piece) was attached to another portion of the white paper sheet. Then, in this evaluation, a color difference ΔE in an L*a*b* color system between the sampling adhesive tape piece and the reference adhesive tape piece was measured by using a spectrophotometer (CM-2600d, manufactured by KONICA MINOLTA, INC.) at a measurement diameter of 8 mm. The color difference ΔE was calculated by the following equation (3):

ΔE=(ΔL²+Δa²+Δ²)^{1/2} (3)

where ΔL is the difference between L* of the sampling adhesive tape piece and L* of the reference adhesive tape piece, Δa is the difference between a* of the sampling adhesive tape piece and a* of the reference adhesive tape piece, and Ab is the difference between b* of the sampling adhesive tape piece and b* of the reference adhesive tape piece.

In this evaluation, the above measurement was performed at each of five portions: two portions near both ends of the photosensitive drum 36 in a main scanning direction (or the left-right direction) and three portions generally equally dividing the space between the two portions. Specifically, at each of the five portions, developer D was taken with a piece of adhesive tape, and the color difference ΔE was measured. Then, an average of the color differences ΔE measured at the five portions was calculated. FIG. 8 shows the relationship between the thickness to equivalent circle diameter ratios of the developers and the color differences ΔE obtained in this evaluation.

In addition, in this evaluation, a color difference threshold TE was set to 2.50, and fog evaluations were performed based on comparisons of the color differences ΔE with the color difference threshold TE. The evaluation results are shown in FIG. 5. Specifically, in this evaluation, when the color difference ΔE of a developer was less than the color difference threshold TE, since the amount of fog toner particles on the printed sheet would be small and the fog toner particles would be unnoticeable, the developer was determined to provide good print quality and rated as “excellent”. Also, in this evaluation, when the color difference ΔE of a developer was not less than the color difference threshold TE, since the amount of fog toner particles on the printed sheet would be large and the fog toner particles would be noticeable, the developer was determined to provide poor print quality and rated as “poor”.

FIG. 5 shows that when the thickness to equivalent circle diameter ratio is not less than 0.74, the image quality is excellent in terms of fog. This is because as the thickness to equivalent circle diameter ratio increases, the shapes of the toner base particles become more spherical, and thus the toner base particles can move more freely in the image forming unit 10. As illustrated on the right side of the row of “fog” of FIG. 11, as the thickness to equivalent circle diameter ratio increases and the shapes of the toner base particles DB become more spherical, the toner base particles DB can move more freely in the image forming unit 10, and thus flow and rotate more easily. Thus, the toner base particles DB are rubbed against each other or between the developing blade 35 and the developing roller 34 more frequently. As a result, the amount of charge of the toner base particles DB increases, which improves the image quality in terms of fog. Conversely, as illustrated on the left side of the row of “fog” of FIG. 11, as the thickness to equivalent circle diameter ratio decreases and the toner base particles DB become flatter, the toner base particles DB can move less freely in the image forming unit 10, and thus flow and rotate less easily. Thus, the toner base particles DB are rubbed against each other or between the developing blade 35 and the developing roller 34 less frequently. As a result, the amount of charge of the toner base particles DB decreases, which degrades the image quality in terms of fog.

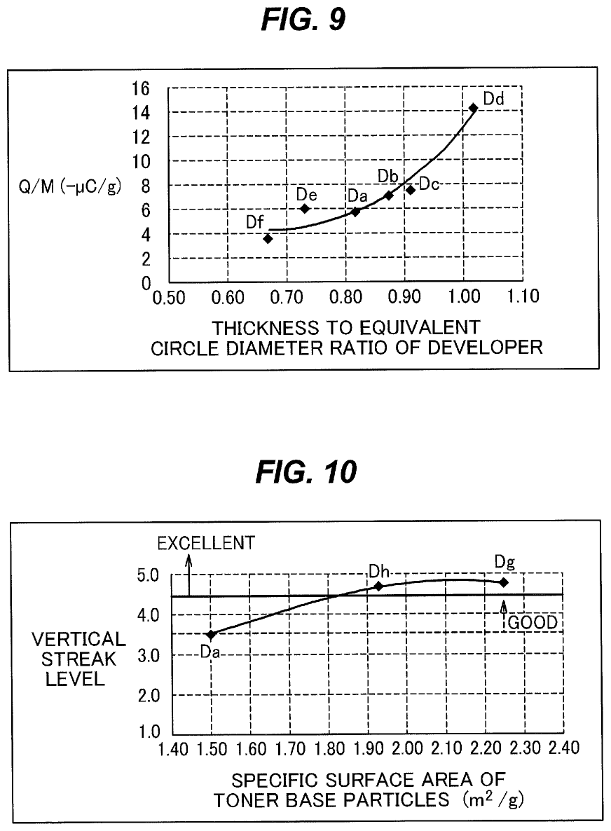

For reference, FIG. 9 shows the relationship between the thickness to equivalent circle diameter ratios and toner charge to mass ratios (Q/m), which are toner charge amounts, on the developing roller 34 of developers Da to Df. For each developer, the toner charge to mass ratio was measured by instantaneously stopping a printing process of an image pattern having a print image density of 0% and measuring developer on the developing roller 34 with a draw-off charge measurement device (210HS-2A, manufactured by TREK JAPAN KK).

### 3-7. DETERMINATION OF THICKNESS TO EQUIVALENT CIRCLE DIAMETER RATIO OF DEVELOPER IN VIEW OF BRILLIANCE AND FOG BASED ON MEASUREMENTS AND EVALUATIONS

Based on the measurement results and evaluation results (see FIG. 5), a condition of the thickness to equivalent circle diameter ratio of the developer D is determined in view of brilliance and fog.

FIG. 5 shows results of print quality evaluations in view of both brilliance and fog, in the column of “comprehensive evaluation” of FIG. 5. Specifically, when the brilliance evaluation was “excellent” and the fog evaluation was “excellent”, since the brilliance was very high and the amount of fog toner particles was small, the print quality was comprehensively evaluated as “excellent”. When the brilliance evaluation was “good” and the fog evaluation was “excellent”, since the brilliance was high and the amount of fog toner particles was small, the print quality was comprehensively evaluated as “good”. When at least one of the brilliance evaluation and fog evaluation was “poor”, the print quality was comprehensively evaluated as “poor”.

FIG. 5 shows that when the thickness to equivalent circle diameter ratio of the brilliant developer is not less than 0.74 and not more than 1.02, the print quality is comprehensively good in view of brilliance and fog, which are the most important quality factors of brilliant developers, and when the thickness to equivalent circle diameter ratio is not less than 0.74 and not more than 0.91, the print quality is comprehensively excellent.

In view of the above, specifically, in this embodiment, developer Df of Comparative Example 1 comprehensively evaluated as “poor” is eliminated, and developers Da to Dc and De of Examples 1 to 3 and 5 comprehensively evaluated as “excellent” and developer Dd of Example 4 comprehensively evaluated as “good” are employed.

### 3-8. EVALUATION OF VERTICAL STREAKS

In this evaluation, for each of developers Da, Dg, and Dh, a vertical streak evaluation was performed by putting the developer D in the developer container 12 (see FIG. 2) of the image forming unit 10S corresponding to the special color of the image forming apparatus 1 (C941dn, manufactured by Oki data Corporation) (see FIG. 1) and then performing a printing process.

Aggregates of external additive particles separated from toner base particles may be stuck between the developing blade 35 and the developing roller 34, preventing developer from forming a developer layer on the developing roller 34 downstream of the aggregates and causing white streaks. The white streaks will be referred to as vertical streaks, in this embodiment. While vertical streaks are one of the important quality factors in normal print products, it is more important for brilliant developers. This is because in the case of brilliant developers, external additive particles easily separate from toner base particles and thus vertical streaks are likely to occur, compared to other developers. As illustrated on the right side of the row of “vertical streaks” of FIG. 11, as the thickness to equivalent circle diameter ratio of the developer D increases and the toner base particles DB become more spherical, the toner base particles DB have more curved surfaces and can move more freely. Thus, when a toner base particle DB is rubbed between the developing blade 35 and the developing roller 34, the toner base particle DB is rubbed more evenly, it is less likely that a load concentrates on a specific portion of the toner base particle DB, and external additive particles E are less likely to separate from the toner base particle DB. This improves the image quality in terms of vertical streaks. Conversely, as illustrated on the left side of the row of “vertical streaks” of FIG. 11, as the thickness to equivalent circle diameter ratio of the developer D decreases and the toner base particles DB become flatter, the toner base particles DB have less curved surfaces and can move less freely. Thus, when a toner base particle DB is rubbed between the developing blade 35 and the developing roller 34, the toner base particle DB is rubbed less evenly, it is more likely that a load concentrates on a specific portion of the toner base particle DB, and external additive particles E are more likely to separate from the toner base particle DB. This degrades the image quality in terms of vertical streaks.

Specifically, in this evaluation, an evaluation pattern having a print image density of 0.3% was printed on paper sheets (Excellent White A4, manufactured by Oki Data

Corporation) as sheets P by the image forming apparatus 1 (C941dn, manufactured by Oki data Corporation) under a printing environment of a temperature of 25° C. and a relative humidity of 40% in such a manner that each paper sheet was fed in the long-edge feed direction (with the two long sides as the leading and trailing edges). Each time the evaluation pattern was printed on 1000 paper sheets by the image forming apparatus 1, an image pattern having a print image density of 100% (i.e., a solid image) was printed, and a level was determined according to the number of vertical streaks thereon. The evaluation pattern was printed on 4000 paper sheets in total, and an average of the determined levels was calculated as a vertical streak level. The level was determined according to the following scale:
Level 5: no vertical streak,
Level 4: 1 or 2 vertical streaks
Level 3: 3 or 4 vertical streaks
Level 2: 5 to 7 vertical streaks
Level 1: 8 or more vertical streaks

In this evaluation, when the vertical streak level was not less than 3.5, the vertical streaks were unnoticeable, and thus the print quality was evaluated to be good. When the vertical streak level was not less than 4.5, the vertical streaks were more unnoticeable, and thus the print quality was evaluated to be excellent. FIG. 10 shows the relationship between the specific surface areas of the toner base particles and the vertical streak levels obtained in this evaluation.

FIG. 10 shows that when the specific surface area of the toner base particles is not less than 1.5068 m²/g, the vertical streaks are unnoticeable, and the print quality is good, and when the specific surface area of the toner base particles is not less than 1.9342 m²/g, the vertical streaks are more unnoticeable, and the print quality is excellent. Although developers were produced under various granulation conditions, the specific surface areas of all the developers were not more than 2.2497 m²/g, which can be said to be a manufacturing limit. Thus, it can be said that when the specific surface area of the toner base particles is not less than 1.5068 m²/g and not more than 2.2497 m²/g, vertical streaks, which are an important quality factor in brilliant developers, are unnoticeable, and the print quality is good, and when the specific surface area of the toner base particles is not less than 1.9342 m²/g and not more than 2.2497 m²/g, vertical streaks are more unnoticeable, and the print quality is excellent.

A reason why the vertical streak level increases as the specific surface area of the toner base particles increases will be described. As illustrated on the right side of the row of “vertical streaks” of FIG. 12, as the specific surface area of the toner base particles DB increases, the surfaces of the toner base particles DB become rougher and have a greater number of recesses and protrusions. Although in general, external additive particles E are separated from toner base particles DB due to loads applied by members of the image forming unit 10 or the like, external additive particles E in recessed portions (or recesses) R are less likely to be applied with loads directly from the members or the like, by virtue of interference by protrusions C. Thus, as the specific surface area increases, external additive particles E are less likely to separate from toner base particles DB, and the vertical streak level increases. Conversely, as illustrated on the left side of the row of “vertical streaks” of FIG. 12, as the specific surface area of the toner base particles DB decreases, the surfaces of the toner base particles DB become smoother. Thus, external additive particles E are more likely to be applied with loads directly from the members or the like. Thus, external additive particles E are more likely to separate from toner base particles DB, and the vertical streak level decreases.

The specific surface area of the toner base particles of a developer D containing the external additive can be made measurable by removing the external additive from the developer D by the following method. In this removal process, a non-ionic surfactant is first added to pure water, and then dispersed in the pure water by stirring the mixture while heating it. The non-ionic surfactant is, for example, polyoxyethylene alkyl ether or the like. As the surfactant, a 5% aqueous solution of EMULGEN (manufactured by Kao Corporation) or the like may be used, for example.

Then, in the removal process, 100 ml (=cm³) of the aqueous surfactant solution is put into a beaker containing 3 g of the developer, and stirred for 40 minutes while being regulated at 25° C. Further, in the removal process, the beaker is placed in a water bath, and then the water bath (at a temperature of 32° C.) is vibrated for 10 minutes by using an ultrasonic vibrator.

Then, in the removal process, the residue is collected by suction filtration of the aqueous surfactant solution. Then, in the removal process, the residue is sufficiently washed and then dried. Thereby, the external additive can be removed from the developer D.

When toner base particles originally having a specific surface area of 1.847 m²/g were added with the external additive, the specific surface area became 2.071 m²/g. Then, when the above-described removal process was performed on the developer having the specific surface area of 2.071 m²/g to remove the external additive, the resulting specific surface area was 1.0221 m²/g.

### 3-9. MEASUREMENT OF CROSS-SECTIONS OF TONER BASE PARTICLES

In this measurement, particle long diameters, particle short diameters, recess opening widths, recess depths, and recess numbers of toner base particles of developer Dc of Example 3 were measured in cross-sections of the toner base particles by using a transmission electron microscope (TEM) (JEM-1400 Plus, manufactured by JEOL Ltd.). Specifically, in this measurement, a predetermined amount of toner base particles of the silver developer was embedded in resin, cut into ultrathin sections, and dyed with ruthenium tetroxide (Ru04). Then, in this measurement, cross-section photographs of the toner base particles of the silver developer were observed with the above-described transmission electron microscope. The measurement conditions were as follows:

Sample Preparation: Ru04 dyeing freeze ultrathin sectioning method

Accelerating Voltage: 100 kV

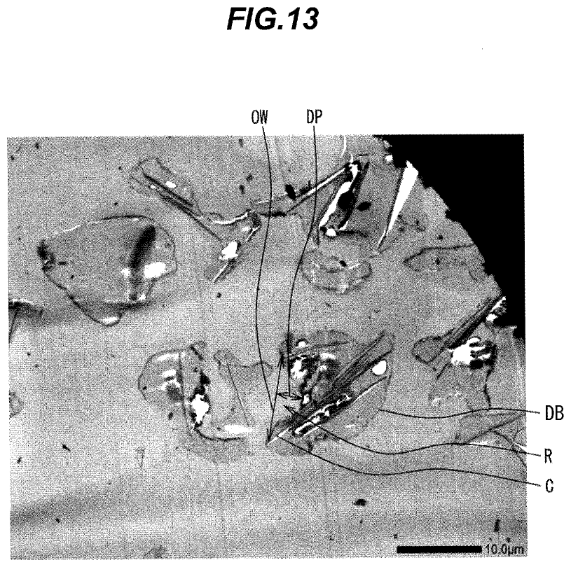

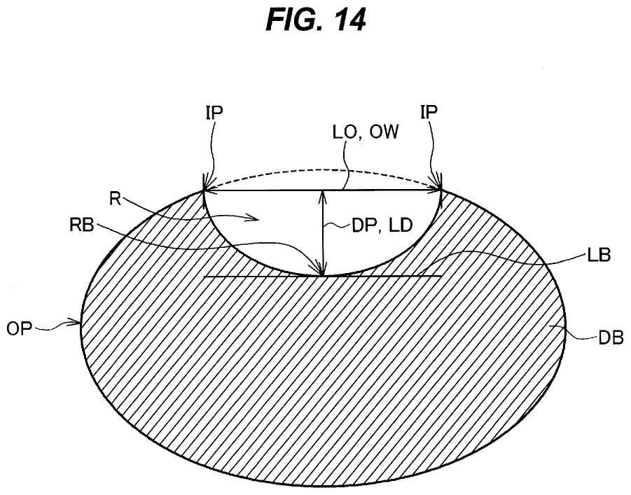

With this observation, transmission electron microscope images as shown in FIG. 13 were obtained. From observed cross-section photographs of the silver developer, 30 toner base particles were randomly selected. For each of the selected toner base particles, a particle long diameter, a particle short diameter, a recess opening width OW, a recess depth DP, and a recess number of the toner base particle were measured in the cross-section of the toner base particle. The particle long diameter is the longest diameter of the toner base particle in the cross-section. The particle short diameter is the shortest diameter of the toner base particle in the cross-section. The recess opening width OW is an opening width of a recess in a surface of the toner base particle. The recess depth DP is a depth of the recess from the surface of the toner base particle. The recess number is the number of recesses. When a toner base particle has multiple recesses, the recess opening width OW and recess depth DP are respectively an opening width and a depth of one of the multiple recesses having the greatest opening width.

Here, the recess opening width OW and recess depth DP will be described with reference to FIG. 14. As schematically illustrated in FIG. 14, a toner base particle DB has a shape flattened from a spherical shape, for example. Also, the toner base particle DB has an outer periphery OP and a recess R recessed from the outer periphery OP toward a center of the toner base particle DB. Points where the outer periphery OP and the recess R are connected to each other will be referred to as inflection points IP. As viewed in a cross-section of the toner base particle DB, the toner base particle DB has two inflection points IP. Also, a portion of the recess R where the depth of the recess R from the outer periphery OP (or the length of the recess R from an opening line LO to be described later in a direction perpendicular to the opening line LO) is greatest will be referred to as a recess bottom RB.

The opening line LO is a line segment connecting the two inflection points IP. The recess opening width OW is the length of the opening line LO. Also, a line parallel to the opening line LO and tangent to the recess bottom RB will be referred to as a bottom line LB. The recess depth DP is a distance between the opening line LO and the bottom line LB, i.e., a length of a depth line LD that is a line segment perpendicular to both the opening line LO and bottom line LB and connecting the opening line LO and the bottom line LB.

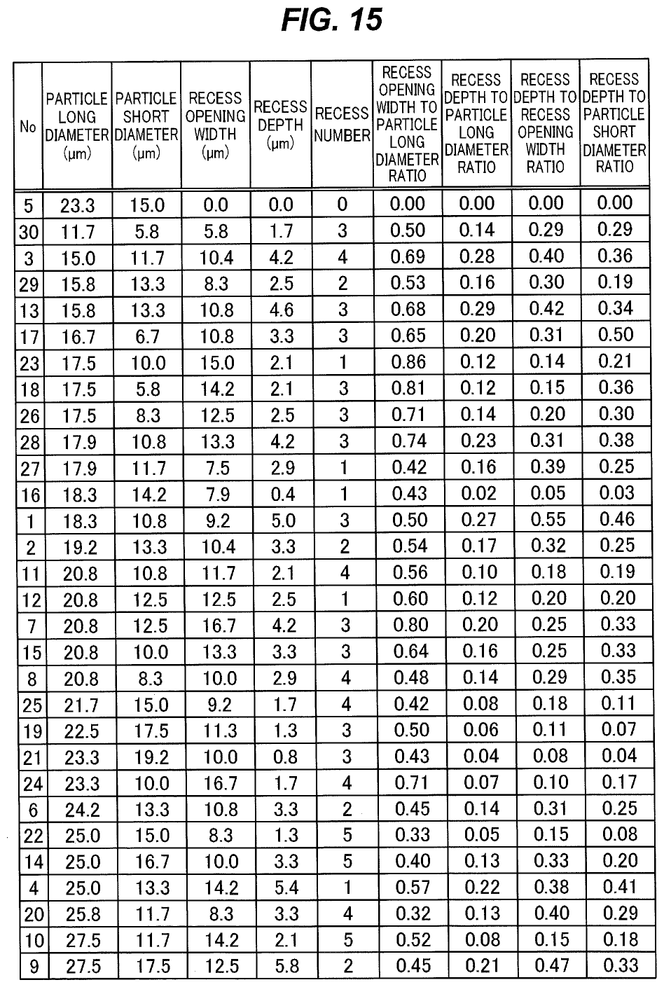

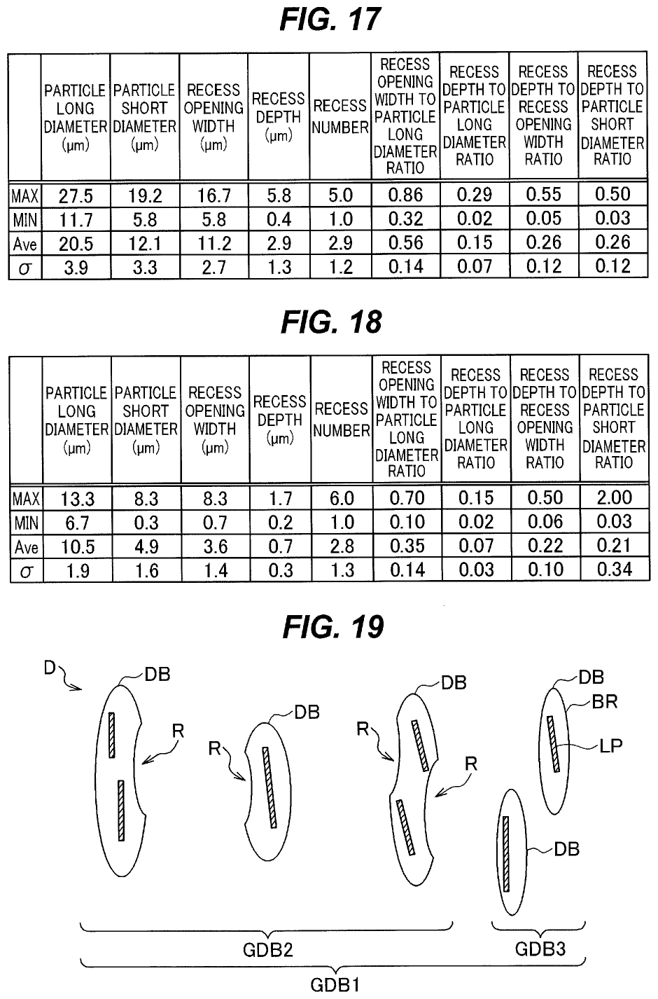

For each of the toner base particles DB, the particle long diameter and particle short diameter were measured. Further, when the toner base particle DB has a recess R, the recess opening width OW and recess depth DP of the recess R, and the recess number were measured, and a ratio of the recess opening width OW to the particle long diameter, a ratio of the recess depth DP to the particle long diameter, a ratio of the recess depth DP to the recess opening width OW, and a ratio of the recess depth DP to the particle short diameter were calculated. The measurement and calculation results are shown in the table of FIG. 15. In FIG. 15, the 30 toner base particles DB are assigned numbers 1 to 30. The toner base particle DB of No. 5 had no recess R. For each of the columns of the table of FIG. 15, a maximum MAX, a minimum MIN, an average Ave, and a standard deviation σ of the values of the toner base particles DB other than the toner base particle DB of No. 5 having no recess R were calculated. The calculation results are shown in FIG. 17. In this observation, 29 of the 30 toner base particles DB had at least one recess R. Thus, in this observation, the percentage of the number of the toner base particles DB having at least one recess R to the total number of the toner base particles DB was not less than 96%.

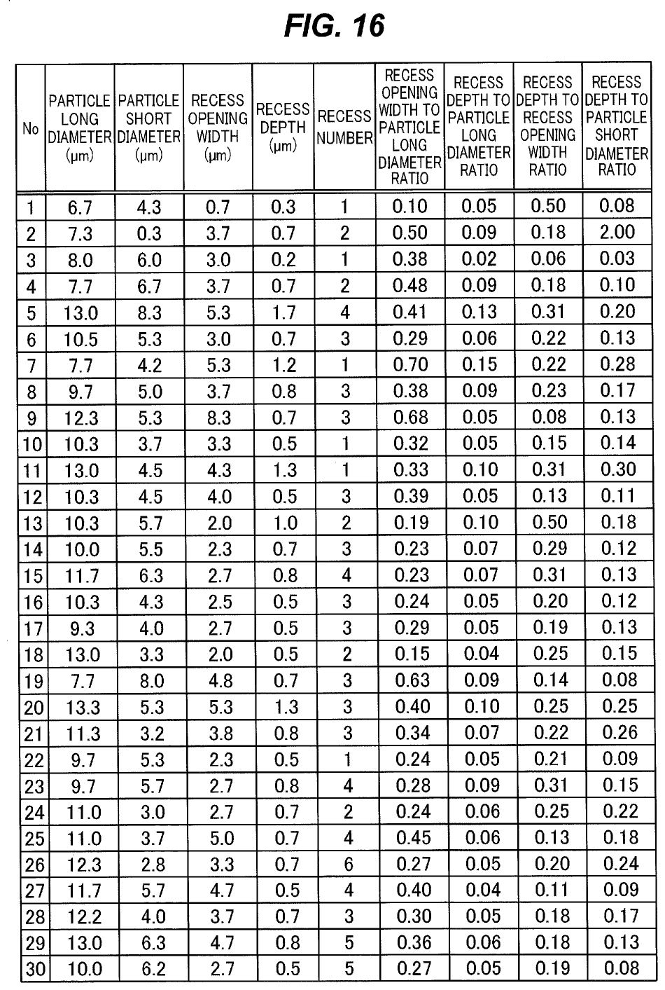

The same measurements were performed on developer Df of Comparative Example 1. The measurement results are shown in the table of FIG. 16. Further, for each of the columns of the table of FIG. 16, a maximum MAX, a minimum MIN, an average Ave, and a standard deviation σ of the values were calculated. The calculation results are shown in FIG. 18.

As shown in FIG. 18, for the developer D of the comparative example, the average plus or minus one standard deviation of the recess opening widths OW was 3.6±1.4 μm. On the other hand, as shown in FIG. 17, for the developer of this embodiment, the average plus or minus one standard deviation of the recess opening widths OW was 11.2±2.7 μm, which is sufficiently greater than that of the developer D of the comparative example. Also, in this observation, as shown in FIG. 15, of the 29 toner base particles DB having at least one recess R, 17 toner base particles DB of No. 3, No. 13, No. 17, No. 26, No. 28, No. 1, No. 2, No. 11, No. 12, No. 15, No. 8, No. 25, No. 19, No. 21, No. 6, No. 14, and No. 9 each had a recess R having a recess opening width OW of 11.2±2.7 μm (i.e., not less than 8.5 μm and not more than 13.9 μm). Thus, in this observation, the percentage of the number of the toner base particles DB having a recess R having a recess opening width OW of 11.2±2.7 μm to the number of the toner base particles DB having at least one recess R was not less than 58%.

Also, as shown in FIG. 18, for the developer D of the comparative example, the average plus or minus one standard deviation of the recess depths DP was 0.7±0.3 μm. On the other hand, as shown in FIG. 17, for the developer D of this embodiment, the average plus or minus one standard deviation of the recess depths DP was 2.9±1.3 μm, which is sufficiently greater than that of the developer D of the comparative example.

Also, the sizes of aggregates of external additive particles were measured to be a few tens of nanometers to 500 nm by using a scanning electron microscope (SEM). While the depths of the recesses R of the toner base particles DB were not less than 0.4 μm and not more than 5.8 μm, when the depths of recesses R are greater than 0.5 μm (i.e., 500 nm), since aggregates of external additive particles E are held in the recesses R, vertical streaks are further reduced.

### 4. ADVANTAGES AND THE LIKE

The image forming apparatus 1 (see FIG. 1) according to this embodiment includes the image forming unit 10S including the developer container 12 (see FIG. 2) containing the silver developer D having brilliance, and thereby can represent a brilliant silver color in an image printed on a sheet P. In this embodiment, the developer D is produced by using a brilliant pigment containing fine aluminum (Al) flakes.

In the image forming apparatus 1, the developer D includes the toner base particles DB containing the brilliant pigment and binder resin, and the toner base particles DB have recesses R. The average plus or minus one standard deviation of the recess opening widths OW of the recesses R of the toner base particles DB determined by observation of cross-sections of the toner base particles DB with a transmission electron microscope is 11.2±2.7 μm. Also, in the image forming apparatus 1, the average plus or minus one standard deviation of the recess depths DP of the recesses R of the toner base particles DB is 2.9±1.3 μm. Further, in the image forming apparatus 1, the recess opening widths OW of the recesses R of the toner base particles DB are not less than 5.8 μm and not more than 16.7 pm. The recess depths DP of the recesses R are not less than 0.4 μm and not more than 5.8 μm. As shown in FIG. 15, for each recess R, the recess opening width OW is greater than the recess depth DP. That is, each recess R satisfies the relationship of OW DP.

The developer D of the image forming apparatus 1 is more likely to hold aggregates of separated external additive particles in the recesses R, compared to a developer D having smaller recesses R. Thus, the image forming apparatus 1 can form a high-quality image while preventing vertical streaks.

Also, as shown in FIGS. 5 and 6, as the thickness to equivalent circle diameter ratio of the brilliant developer increases, the brilliance degrades, but the image quality improves in terms of fog. As shown in FIG. 5, when the thickness to equivalent circle diameter ratio of the brilliant developer is not less than 0.74 and not more than 1.02, the image quality is good in terms of both brilliance and fog, which are the most important quality factors of brilliant developers, and when the thickness to equivalent circle diameter ratio is not less than 0.74 and not more than 0.91, the image quality is excellent in terms of both brilliance and fog.

Further, as shown in FIG. 10, when the specific surface area of the toner base particles is not less than 1.5068 m²/g, the print quality is good with vertical streaks unnoticeable, and when the specific surface area of the toner base particles is not less than 1.9342 m²/g, the print quality is excellent with vertical streaks more unnoticeable. Also, it can be said that 2.2497 m²/g is a manufacturing limit of the specific surface area of the toner base particles. Thus, it can be said that when the specific surface area of the toner base particles is not less than 1.5068 m²/g and not more than 2.2497 m²/g, the print quality is good with vertical streaks, which are an important quality factor of brilliant developers, unnoticeable, and when the specific surface area of the toner base particles is not less than 1.9342 m²/g and not more than 2.2497 m²/g, the print quality is excellent with vertical streaks more unnoticeable.

Also, the evaluation results of Comparative Example 1 shows that when the thickness to equivalent circle diameter ratio of the developer D is 0.67, which is small, although the FI value is not less than 10 and thus good, the color difference ΔE is not less than 2.5 and thus the image quality is poor in terms of fog. On the other hand, according to the evaluation results of Examples 1 to 7, when the thickness to equivalent circle diameter ratio of the brilliant developer is not less than 0.74 and not more than 1.02 and the specific surface area of the toner base particles is not less than 1.5068 m²/g and not more than 2.2497 m²/g, the image quality is at least good in terms of each of brilliance, fog, and vertical streaks, which are issues and important quality factors specific to brilliant developers. Further, when the thickness to equivalent circle diameter ratio of the brilliant developer is not less than 0.74 and not more than 0.91 and the specific surface area of the toner base particles is not less than 1.9342 m²/g and not more than 2.2497 m²/g, the image quality is excellent in terms of each of brilliance, fog, and vertical streaks.

Thus, by using a developer D satisfying such conditions, the image forming apparatus 1 can form a high-quality image having sufficient brilliance on a sheet P while preventing fog, i.e., preventing developer D from adhering to an undesired portion of the sheet P, and preventing vertical streaks.

As described above, in this embodiment, since the toner particles of the developer D contain aluminum (Al), which is metal, there is a possibility that the toner particles have insufficient chargeability. However, by setting the thickness to equivalent circle diameter ratio appropriately, the chargeability is improved to prevent fog, and the print quality is improved in terms of both fog and the FI value.

As described above, in the image forming apparatus 1, the recess opening widths OW and recess depths DP of recesses R of the toner base particles DB of the brilliant developer are appropriately set. Also, in the image forming apparatus 1, the thickness to equivalent circle diameter ratio of the brilliant developer is appropriately set. Thereby, the image forming apparatus 1 can form a high-quality image in terms of brilliance, fog, and vertical streaks, and provide an excellent printed product.

With the above configuration, in the image forming apparatus 1 according to this embodiment, the developer container 12 of the image forming unit 10S contains a brilliant developer D. The developer D contains toner base particles DB containing a brilliant pigment LP and a binder resin BR, as illustrated in FIG. 19. Some of the toner base particles DB each have a recess R having an opening width of 11.2±2.7 μm. Specifically, as illustrated in FIG. 19, a toner base particle group GDB1 consisting of the toner base particles DB contains a toner base particle group GDB2 that is a group of toner base particles DB having at least one recess R and a toner base particle group GDB3 that is a group of toner base particles having no recess R. The toner base particle group GDB2 contains toner base particles DB having a recess R having an opening width of 11.2±2.7 μm.

Thus, in this developer D, aggregates of external additive particles separated from the toner base particles DB are likely to be held in the recesses R. By using this developer D, the image forming apparatus 1 can form a high-quality printed image while preventing vertical streaks.

### 5. MODIFICATIONS

The above embodiment describes using a transmission electron microscope (TEM) to measure the particle long diameters, particle short diameters, recess opening widths, recess depths, and recess numbers of cross-sections of toner base particles of a silver developer. However, this is not mandatory, and other various measuring devices, such as a scanning electron microscope (SEM) or a scanning probe microscope (SPM), may be used to measure the particle long diameters, particle short diameters, recess opening widths, recess depths, and recess numbers of cross-sections of toner base particles of a silver developer.

Also, in the above embodiment, to adjust the thickness, equivalent circle diameter, or specific surface area of the toner base particles, it is possible to change the liquid temperature, the pH of the system, or the stirring speed in the granulation, and it is also possible to add additive(s).

Also, in the above embodiment, the brilliant pigment used in producing the developer D contains fine aluminum (Al) flakes having flat portions. However, this is not mandatory, and aluminum particles having other shapes, such as spherical shapes or rod shapes, may be used.

Also, in the above embodiment, the brilliant pigment used in producing the developer D contains aluminum (Al). However, this is not mandatory, and other metals, such as brass or iron oxide, may be used. In this case, the color exhibited by the developer fixed to a sheet P depends on the metal.

Further, in the above embodiment, developers used for one-component development have been described. However, this is not mandatory, and embodiments of the present invention are applicable to developers for other development methods, such as two-component development using carriers.

Further, in the above embodiment, the image forming apparatus 1 (see FIG. 1) is provided with five image forming belt 10. However, this is not mandatory, and the image forming apparatus 1 may be provided with four or less or six or more image forming belt 10.

Further, in the above embodiment, the present invention is applied to a single function printer. However, this is not mandatory, and embodiments of the present invention are applicable to image forming apparatuses having other functions, such as multi-function peripherals (MFPs) having a copier function and a facsimile function.

Further, in the above embodiment, the present invention is applied to an image forming apparatus. Embodiments of the present invention are applicable to various electronic devices, such as copiers, that form images on media, such as paper sheets, with developer by electrophotography.

Further, embodiments of the present invention are not limited to the above embodiment and modifications. Specifically, embodiments of the present invention may include embodiments obtained by arbitrarily combining some or all of the features of the above embodiment and modifications, and embodiments obtained by extracting some of the features of the above embodiment and modifications.

Further, in the above embodiment, the image forming apparatus 1 as an image forming apparatus is constituted by the image forming unit 10 as an image forming unit including the photosensitive drum 36 as an image carrier, the developing roller 34 as a developer carrier, the developing blade 35 as a layer regulating member, the first supply roller 32, the second supply roller 33, and the developer D as a brilliant developer, and the fixing unit 70 as a fixing unit. However, this is not mandatory. An image forming apparatus may be constituted by an image forming unit including an image carrier, a developer carrier, a layer regulating member, and a brilliant developer, and a fixing unit that have other configurations.

Embodiments of the present invention can be used in forming an image on a medium with a developer containing a metallic pigment by electrophotography.

What is claimed is:

1. A brilliant developer comprising:
toner base particles containing a brilliant pigment and a binder resin,
wherein some of the toner base particles each have a recess having an opening width of 11.2±2.7 μm.

2. The brilliant developer of claim 1, wherein the recess has a depth of 2.9±1.3 μm.

3. The brilliant developer of claim 2, wherein the recess satisfies a relationship that the opening width is greater than the depth.

4. The brilliant developer of claim 1, wherein the recess is measured by observation of a cross-section of the toner base particle with a transmission electron microscope.

5. The brilliant developer of claim 1, wherein the toner base particles have a specific surface area of not less than 1.5068 m²/g and not more than 2.2497 m²/g.

6. The brilliant developer of claim 5, wherein the toner base particles have a specific surface area of not less than 1.9342 m²/g and not more than 2.2497 m²/g.

7. The brilliant developer of claim 1, wherein a ratio A/B of a thickness A to an equivalent circle diameter B of the brilliant developer is not less than 0.74 and not more than 1.02.

8. The brilliant developer of claim 7, wherein the ratio A/B of the thickness A to the equivalent circle diameter B of the brilliant developer is not less than 0.74 and not more than 0.91.

9. The brilliant developer of claim 1, wherein the toner base particles have a volume average particle size of not less than 14.87 μm and not more than 16.15 μm.

10. The brilliant developer of claim 1, wherein the brilliant developer further comprises silica, and a content of the silica determined by EDX measurement is 2.200 to 2.300 wt %.

11. The brilliant developer of claim 1, wherein the toner base particles contain toner base particles each having a recess, and a percentage of a number of the toner base particles each having a recess to a total number of the toner base particles is not less than 96%.

12. The brilliant developer of claim 11, wherein the toner base particles each having a recess contain toner base particles each having a recess having an opening width of 11.2±2.7 μm, and a percentage of a number of the toner base particles each having a recess having an opening width of 11.2±2.7 μm to the number of the toner base particles each having a recess is not less than 58%.

13. A developer container comprising a storage portion that contains the brilliant developer of claim 1.

14. An image forming unit comprising:
an image carrier that carries an electrostatic latent image;
a developer carrier that forms a developer image based on the electrostatic latent image on the image carrier;
a layer regulating member that abuts the developer carrier; and
the brilliant developer of claim 1.

15. An image forming apparatus comprising:
the image forming unit of claim 14; and
a fixing unit that fixes the developer image formed by the image forming unit to a medium.
